(19) United States
(12) Patent Application Publication
(10) Pub. No.: US 2008/0160911 A1
(43) Pub. Date: Jul. 3, 2008

(54) P2P-based broadcast system and method using the same

(75) Inventors: Cheng-Fu Chou, Taipei City (TW); Han-wu Chou, Fremont, CA (US); Cheng-sean Chen, Hsin-Chu (TW)

Correspondence Address: REED SMITH LLP, Suite 1400, 3110 Fairview Park Drive, Falls Church, VA, 22042, US

(73) Assignee: Goosean Media Inc.

(21) Appl. No.: 11/797,873

(22) Filed: May 8, 2007

Related U.S. Application Data
(63) Continuation-in-part of application No. 11/645,755, filed on Dec. 27, 2006.
(60) Provisional application No. 60/877,690, filed on Dec. 29, 2006.

(51) Int. Cl. H04B 3/36

(52) U.S. Cl. 455/7

(57) ABSTRACT

The present invention is to disclose a peer-to-peer based broadcast system for broadcasting video contents, comprising at least one video head-end means for receiving a plurality of original video contents, said video head-end means comprising a splitter to split each original video content into a plurality of video files for each video file being formed of a group of pictures (GOPs) based on said GOPs' boundaries, and said video head-end means further comprising at least one content repository means for storing said video files corresponding to each of original video contents; at least one relay means for receiving and broadcasting some of said video files (190) from the video head-end means; a plurality of peers for receiving and broadcasting some of said video files; at least one super seed means for receiving said video files from said relay means and/or said peers, and broadcasting said files to some of said peers; at least one network management means for managing connections among said super seed means and said peers, said network management means comprising at least one tracking means for storing all required location information of said video files; and at least one system management means for providing authentication and authorization for clients on said peers to access to said P2P based broadcast system; wherein said each peer comprising a player for processing said video files so as to play said original video contents when said video files being received.

This application is a continuation-in-part of application Ser. No. 11/645,755 filed Dec. 27, 2006. This application also claims the benefit of Provisional Application Ser. No. 60/877,690 entitled “Timezone-shifting IP-based video broadcasting system and method using the same” filed Dec. 29, 2006 in the names of the same inventors hereof. The disclosure of the Provisional Application is incorporated herein.

### BACKGROUND OF THE INVENTION

1. Field of the Invention

The present invention relates to a peer-to-peer (P2P) based broadcast system, and more particularly to a P2P based broadcast system for broadcasting video contents.

2. Description of the Related Art

With the advent of networking communications technology, many people's daily lives are closely related to the Internet/Intranet business and are significantly impacted by the Internet/Intranet technology's evolution and revolution. More and more people have used the Internet/Intranet and even accessed/browsed the Internet/Intranet in their daily lives, whether for work, entertainment, shopping, or education, etc. The Internet/Intranet is creating a new economy, which is competing with people's traditional way of living.

It's known that IP-based TVs were proposed several years ago. IP-based TVs were proposed to provide people the possibility of obtaining internet/intranet access at a location, such as at home, by using only a regular PC with software installed or a device (e.g. set top box). Although people may enjoy watching video contents (e.g. television shows or programs) which have been broadcasted over the internet/intranet, however, some service providers for offering IP-based TVs do not guarantee the quality of services to customers since it's free. In addition, most of the local telecom carriers, on-line TV providers, and web-site companies provide the video content in their own mother or familiar languages rather than other foreign languages; for example, all the Asian Americans are difficult to receive the high quality of Asian TV programs which are originally broadcast in Asia.

In current network environments, there is wide interest for clients to receive such digital video contents as TV programs provided by internet content providers in a faster way. However, referred to FIG. 1, the conventional client/server network architecture does not fulfill the client's needs due to lack of available bandwidth of the network and heavy workload of the central server. In case of network traffic congestion, when a particular video content is being accessed by many clients and it will take much time for downloading the complete video content from the central server.

In order to resolve the above-mentioned problem, a peer-to-peer (P2P) network architecture was provided to spread the heavy data load of the central server by means of providing a number of peer and/or seed nodes, each having the processing power, instead of an only exclusive central server handling the enormous amount of video contents for transmission. Therefore, each of the video contents (so called TV programs) is divided into a number of video files which are stored at different peer or seed nodes in different locations. When a client wants to watch a TV program in a specific channel, the P2P network will deliver a group of torrent files to the client, and the client will receive a plurality of video files based on the group of torrent files indicating the IP addresses of peer and/or seed nodes so as to access the video files from different peer or seed nodes according to their IP addresses.

However, from one aspect of the current P2P content delivery network, it is highly challenging for watching P2P broadcast contents because a client cannot watch a complete video content until all the required video files have been received. From another aspect of P2P content delivery network, even if the current P2P network architecture can provide the client with the streaming-like service such as one part of content for watching while the other part for downloading, as the current P2P network is used to slice each video content (e.g. 1-hour program) into a plurality of video files with fixed size (such 10-minute video click), and each video file is composed of a number of group of pictures (i.e. GOP for the basic unit of each video file), so it will cause a serious audio/video asynchronous problem resulting from missing frames and/or overlapping frames when the sliced video files not sliced by each GOP boundary are combined for video streaming.

Accordingly, a need exists for a scalable and robust P2P based video content delivery network that provide the efficient solution of scalable quasi-real-time content broadcasting service while minimizing the potential the cost of distribution of the video content as much as possible.

### SUMMARY OF THE INVENTION

In order to solve the above-mentioned problems, the present invention provides a peer-to-peer (P2P) based broadcast system and method using the same for broadcasting video contents, which comprises at least one video head-end means for receiving a plurality of original video contents, said video head-end means comprising a splitter to split each of video contents into a plurality of video files for each video file being formed of a group of pictures (GOPs) based on said GOPs' boundaries, and said video head-end means further comprising at least one content repository means for storing said video files corresponding to each of original video contents; at least one relay means for receiving and broadcasting some of said video files from the video head-end means; a plurality of peers for receiving and broadcasting some of said video files; at least one super seed means for receiving said video files from said relay means and/or said peers, and broadcasting said files to some of said peers; at least one network management means for managing connections among said super seed means and said peers, said network management means comprising at least one tracking means for storing all required location information of said video files; and at least one system management means for providing authentication and authorization for clients on said peers to access to said P2P based broadcast system; wherein, said each peer comprising a player for processing said video files so as to play said original video contents when said video files being received.

Therefore, the main object of the present invention is to provide a splitter located in a head-end means for splitting each of video contents, based on each of GOPs, into a number of video files for each being composed of the GOPs so that a peer node may receive the video contents more efficiently than a conventional P2P based broadcast system.

Another object of the present invention is to provide a P2P based broadcast system which comprises a splitter located in a relay means for splitting each of video contents, based on each of GOPs, into a number of video files for each being composed of the GOPs so that video contents can be received by a peer node more efficiently than a conventional P2P based broadcast system.

Yet another object of the present invention is to provide a player in each of peer nodes for receiving a plurality of video files so that a client through the player in the peer node may receive and play the video files together.

Yet another object of the present invention is to provide a P2P based broadcast method which allocate a splitter located in a head-end means for splitting each of video contents, based on each of GOPs, into a number of video files for each being composed of the GOPs so as to improve the quality of broadcast bandwidth over the P2P based broadcast system.

Yet another object of the present invention is to provide a P2P based broadcast method which allocate a splitter located in a relay means for splitting each of video contents, based on each of GOPs, into a number of video files for each being composed of the GOPs so as to improve the quality of broadcast bandwidth over the P2P based broadcast system.

### BRIEF DESCRIPTION OF THE DRAWINGS

FIG. 1 is an illustration of the conventional client/server network;

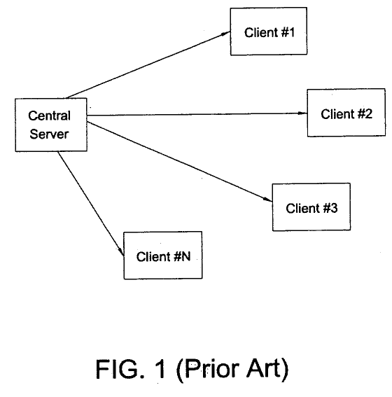

FIG. 2 is an illustration of the broadcasting system according to the first preferable embodiment of the present invention;

FIG. 3 is an illustration of the broadcasting system according to the second preferable embodiment of the present invention;

FIG. 4 is an illustration of the video content player according to the third preferable embodiment of the present invention; and

FIG. 5 is an illustration of the frame structure of each video file.

### DETAILED DESCRIPTION OF THE EMBODIMENTS

The present invention discloses a peer-to-peer (P2P) based broadcasting system and the method using the same for broadcasting the video contents via the internet and/or intranet, wherein the basic principles or techniques of the network communications are well-known by those skilled in the art, the following description will omit the description of the principles. Moreover, the diagrams included in the following are not completely drawn according to the real size and are only used to demonstrate features related to the present invention.

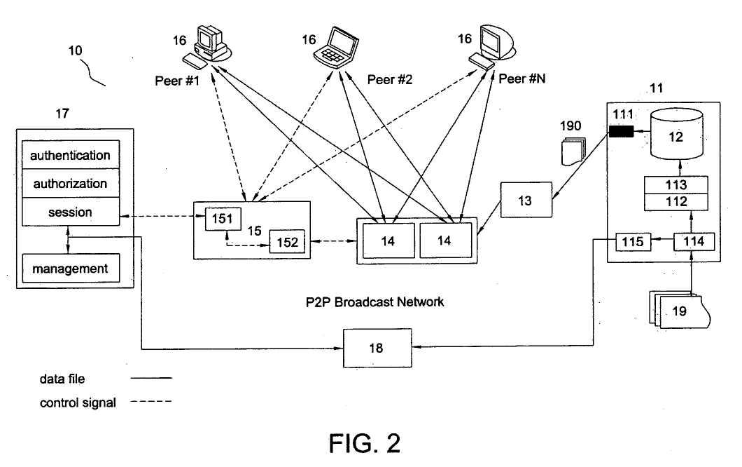

FIG. 2 is a P2P based video broadcasting system according to the first preferable embodiment of the present invention. The P2P based broadcast system 10 comprises at least one video head-end means 11 having at least one content repository means 12; at least one relay means 13; at least one super seed means 14; at least one network management means 15; a plurality of peers 16; and at least one system management means 17. The video head-end means, content repository means, relay means, super seed means, peers, and system management means herein are also referred to as video head-end sever(s), content repository storage, relay sever(s), super seed node(s), peer nodes, and system management sever(s), respectively.

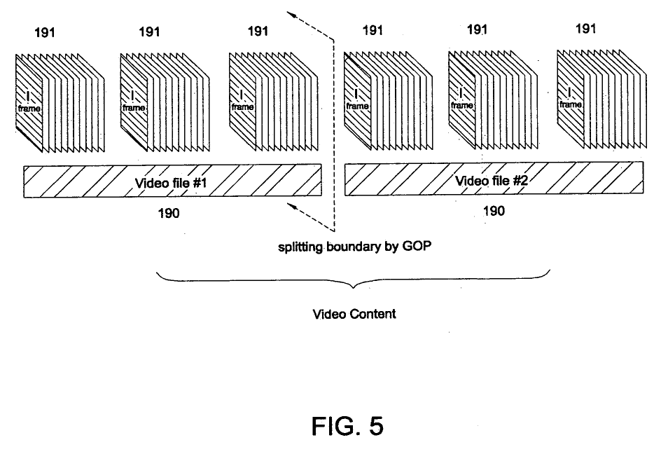

The video head-end servers 11 is adapted for receiving a plurality of original video contents 19 which comprises a splitter 111 to slice each of original video contents 19 (i.e. TV programs) into a plurality of video files 190, for each video file 190 which is composed of a group of pictures (GOPs) 191. GOP is a minimum unit in each video file 190 during file transmission. Please referred to FIG. 5, the splitting boundary between the two consecutive video files is based on GOP rather than a fixed file size. The video head-end server 11 further comprises a content repository storage 12 for storing the video files 190 of original TV programs 19.

The relay server 13 is adapted for receiving video files 190 from the video head-end server 11 and broadcasting the video files 190 to super seed nodes 14 in the P2P based network.

The super seed node 14 is adapted for receiving the video files 190 from the relay server 13 and broadcasting the video files 190 to the peer nodes 16 in response to the request from the clients. The peer node 16 is provided for receiving the video files 190 from the super seed node 14 and broadcasting the video files 190 to other peer nodes 16.

The network management server 15 is adapted for managing connections among the super seed nodes 14 and the peer nodes 16, and comprises at least a tracking means 151 (i.e. tracker) for storing all required location information of the video files. The system management server 17 is adapted for providing authentication and authorization for clients on the peer nodes 16 for access to the P2P based broadcast system 10, wherein each peer node 16 comprises a player for processing the video files so as to play the TV programs when the video files are being received. The player is implemented by using only a regular PC with software installed or a device (e.g. set top box).

In the above mentioned embodiment, the location information of the video files 190 in the network management server 17 is received by the peer nodes 16. The authentication and authorization provided by the system management server 17 makes session validations between the system management server 17 and the network management server 15, and decides what services clients may access to. The network management server 15 further comprises a torrent means 152 (e.g. torrent servers) for storing a plurality of torrent files each indicating a corresponding location of each tracker.

In the above mentioned embodiment, the P2P based broadcast system 10 further comprises at least a web portal server 18 (i.e. web portal) which is adapted for managing client accounts on the peer nodes and providing web services to clients via the peer nodes. The web services provided by the web portal 18 are selected from the group consisting of electronic program guide, language selection, channel selection, commercial promotion, and the like such as personalized services based on the interest of clients.

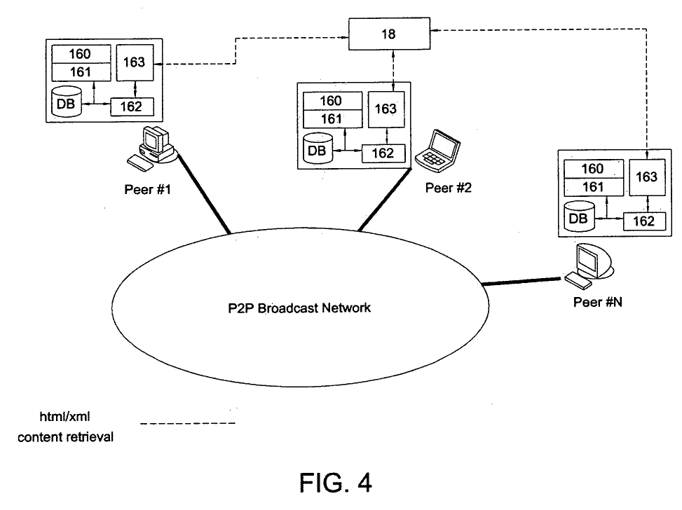

In the above mentioned embodiment, referred to FIG. 4, the player provided in each peer node 16 further comprises a decoding means 160, a DRM-MUX means 161, agent means 162 (i.e. p2p agent) and a user interface means 163 (i.e. user interface) for processing the received video files so that clients may watch the original TV programs 19. The decoding means 160 is provided for decoding each of video files. The DRM-MUX means 161 is provided for multiplexing a DRM header on each of video file 190. The agent means 162 is provided for receiving torrent files to identify locations of the trackers so as to receive the video files 190 and append therein sequentially. The user interface 163 is provided for playing the video files so that clients may watch the original TV programs when the video files are being received and appended.

In the above mentioned embodiment, each GOP 191 (shown in FIG. 5) comprises a set of video frames started with an independent frame (I-frame), and subsequently with a plurality of predictive frame (P-frame) and a plurality of bidirectional frame (B-frame). On the other hand, GOP 191 is a minimum unit in each video file 190.

In the above mentioned embodiment, the head-end server 11 further comprises an encoding means 112 adapted for compressing each of the video files. In addition, the head-end server 11 further comprises a DRM-H means 113 adapted for providing a digital right management heading operation on each of the video files. In addition, the head-end server 11 further comprises an editing means 114 adapted for editing the video files. In addition, the video head-end server further comprises a EPG means 115 adapted for generating a electronic TV program guide and delivering the electronic TV program guide to the peer nodes.

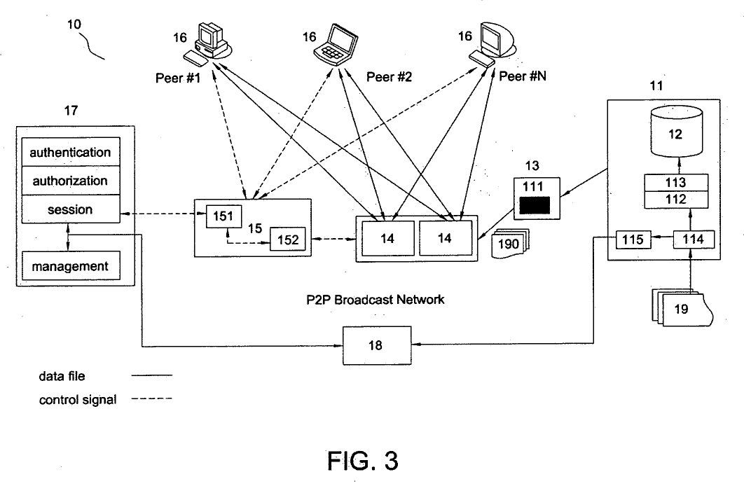

FIG. 3 is a P2P based video broadcasting system according to the second preferable embodiment of the present invention. The P2P based broadcast system 10 comprises at least one video head-end means 11 having at least one content repository means 12; at least one relay means 13; at least one super seed means 14; at least one network management means 15; a plurality of peers 16; and at least one system management means 17. The video head-end means, content repository means, relay means, super seed means, peers, and system management means herein are also referred to as video head-end sever(s), content repository storage, relay sever(s), super seed node(s), peer nodes, and system management sever(s), respectively.

The video head-end server 11 is adapted for receiving a plurality of original video contents 19 (i.e. TV programs) and converting each of the original TV programs into digital TV programs, and the video head-end server 11 further comprises at least one content repository storage 12 for storing the digital TV programs.

The relay server 13 is adapted for receiving the digital TV programs 19 from the video head-end server 11 and further comprises a splitter 111 to slice each of the digital TV programs 19 into a plurality of video files 190, wherein each video file 190 is composed of a group of pictures (GOPs) 191. GOP is a minimum unit of each video file 190 during transmission. Please referred to FIG. 5, the splitting boundary between the two consecutive video files is based on GOP rather than a fixed file size. The plurality of video files 190 are then sent out in broadcast way from the relay server 13 to super seed nodes 14.

The super seed nodes 14 are adapted for receiving the video files 190 from the relay server 13 and broadcasting the video files 190 to the peer nodes 16. The peer nodes 16 are adapted for receiving the video files 190 from the super seed nodes 14 and/or peer nodes 16, and are adapted for broadcasting the video files 190 to other peer nodes 16.

The network management server 15 is adapted for managing connections among the super seed nodes 14 and the peer nodes 16, and comprises at least a tracking means 151 (i.e. tracker) for storing all required location information of the video files. The system management server 17 is adapted for providing authentication and authorization for clients on the peer nodes 16 for access to the P2P based broadcast system 10, wherein each peer node 16 comprises a player for processing the video files so as to play the original video contents when the video files are being received. The player is implemented by using only a regular PC with software installed or a device (e.g. set top box).

FIG. 4 is a player provided in a peer-to-peer based broadcast system for receiving and playing video files according to the third preferable embodiment of the present invention, wherein the player in each peer node comprises a decoding means 160, a DRM-MUX means 161, agent means 162 (i.e. p2p agent) and a user interface means 163 (i.e. user interface) for processing the received video files so that clients may watch the original TV programs 19. The decoding means 160 is provided for decoding each of video files. The DRM-MUX means 161 is provided for multiplexing a DRM header on each of video file 190. The agent means 162 is provided for receiving torrent files to identify locations of the trackers so as to receive the video files 190 and append therein sequentially. The user interface 163 is provided for playing the video files so that clients may watch the original TV programs when the video files are being received and appended.

In addition, the present invention also disclose a content retrieval method according to the above-mentioned player, which comprises the steps

(1) Sending a request to a network management server 15 from a client via a peer node 16 for determining what video content/TV program 19 to watch;

(2) Getting from the network management server 15 a message containing the number of torrent files, the address of a torrent means 152 for storing the torrent files, and the sequence number for playing the video content/TV program 19;

(3) Fetching the torrent files based on the address of the torrent means 152 and, and queuing the torrent files in the peer 16, thus the client can find out the locations of trackers based on the torrent files, and furthermore, the purpose of trackers will tell the peer node 16 the IP addresses of super seed nodes 14 and/or other peer nodes 16 having the respective video files 190 corresponding to the content/TV program 19 which the client is desirable to watch;

(4) Receiving a plurality of video files 190 from the super seed nodes 14 and/or peer nodes 16, the peer node 16 receives the plurality of video files 190 sliced by a splitter 111 in a sequential order;

(5) Combining and appending the plurality of video files 190, the peer node proceeds to complete the task of combining and appending the video files 190;

(6) Processing said sequential video files 190 by a player provided in the peer node 16 for watching the video content/TV program 19, the peer node 16 displays the video content/TV program 19; and

(7) Repeating the step (1) to (6) if the client stopping the video content/TV program 19 and switching another video content/TV program 19.

In addition, the present invention also discloses a P2P based broadcast method according to the P2P broadcast system of the first preferable embodiment for broadcasting video contents, which comprises the steps of:

(1) allocating at least one video head-end server 11 for receiving a plurality of original video contents/TV programs 19, wherein the video head-end means 11 comprises a splitter to split each original video content 19 into a plurality of video files 190 for each video file being formed of a group of pictures (GOPs) 191 based on the GOPs' boundaries, and the video head-end means 11 further comprises at least one content repository storage 12 for storing the video files corresponding to each of original video contents/TV programs;

(2) allocating at least one relay server 13 for receiving and broadcasting some of the video files 190 from the video head-end server 11;

(3) allocating a plurality of peer nodes for receiving and broadcasting some of the video files 190;

(4) allocating at least one super seed nodes 14 for receiving the video files 190 from the relay means 13 and/or peers, and broadcasting the video files 190 to some of the peer nodes;

(5) allocating at least one network management server 15 for managing connections among the super seed nodes 14 and peer nodes, wherein the network management servers comprises at least one tracker for storing all required location information of the video files; and

(6) allocating at least one system management server 17 for providing authentication and authorization for clients on the peer nodes to access to the P2P based broadcast system; wherein each peer node comprises a player for processing the video files so as to play the video contents/TV programs when the video files are being received.

In addition, the present invention also discloses a P2P based broadcast method according to the P2P broadcast system of the second preferable embodiment for broadcasting video contents, which comprises the steps of:

(1) allocating at least one video head-end server 11 for receiving a plurality of original video contents/TV programs 19, wherein the video head-end means 11 comprises at least one content repository storage 12 for converting the original video contents/TV programs 19 into the digital video contents/TV programs 19;

(2) allocating at least one relay server 13 for receiving the digital video contents/TV programs 19 from the video head-end server 11; wherein the relay server 13 comprises a splitter to split each digital video content/TV programs 19 into a plurality of video files 190 for each video file being formed of a group of pictures (GOPs) 191 based on the GOPs' boundaries, and broadcasts the video files 190 to super seed nodes 14;

(3) allocating a plurality of peer nodes for receiving and broadcasting some of the video files 190;

(4) allocating at least one super seed nodes 14 for receiving the video files 190 from the relay server 13, and broadcasting the video files 190 to some of the peer nodes;

(5) allocating at least one network management server 15 for managing connections among the super seed nodes 14 and peer nodes, wherein the network management servers comprises at least one tracker for storing all required location information of the video files; and

(6) allocating at least one system management server 17 for providing authentication and authorization for clients on the peer nodes to access to the P2P based broadcast system; wherein each peer node comprises a player for processing the video files so as to play the video contents/TV programs when the video files are being received.

The above mentioned preferred embodiments of the present invention are not meant to limit the scope of the present invention. The description of the present invention should be understood by those skilled in the art. Moreover, any changes or modifications or the equivalent thereof that can be made without departing from spirit of the present invention should be protected by the following claims.

In view of the above teaching, other embodiments may be envisioned by those skilled in the art without departing from the spirit of the invention.

What is claimed is:

1. A peer-to-peer (P2P) based broadcast system for broadcasting video contents, comprising
at least one video head-end means for receiving a plurality of original video contents, said video head-end means comprising a splitter to split each original video content into a plurality of video files for each video file being formed of a group of pictures (GOPs) based on said GOPs' boundaries, and said video head-end means further comprising at least one content repository means for storing said video files corresponding to each of original video contents;
at least one relay means for receiving and broadcasting some of said video files from the video head-end means;
a plurality of peers for receiving and broadcasting some of said video files;
at least one super seed means for receiving said video files from said relay means and/or said peers, and broadcasting said files to some of said peers;
at least one network management means for managing connections among said super seed means and said peers, said network management means comprising at least one tracking means for storing all required location information of said video files; and
at least one system management means for providing authentication and authorization for clients on said peers to access to said P2P based broadcast system;
wherein, said each peer comprising a player for processing said video files so as to play said original video contents when said video files being received.

2. The P2P based broadcast system of claim 1, wherein the location information of said video files in said at least one network management means is received by said peers.

3. The P2P based broadcast system of claim 1, wherein the authentication and authorization makes session validation between the system management means and network management means, and decides what services clients may access to.

4. The P2P based broadcast system of claim 1, wherein the network management means further comprises a torrent means for storing a plurality of torrent files each indicating a corresponding location of each tracker means.

5. The P2P based broadcast system of claim 1, wherein the P2P based broadcast system further comprises at least a web portal means for managing accounts of clients on said peers and providing web services to clients via said peers.

6. The P2P based broadcast system of claim 5, wherein the web services provided by said web portal means is selected from the group consisting of electronic program guide, language selection, channel selection, commercial promotion, and the like such as personalized services based on the interest of clients.

7. The P2P based broadcast system of claim 1, wherein the player provided in each peer further comprises a decoding means, a DRM-MUX means, agent means and a user interface means for processing said received said video files so that clients may watch said original video content.

8. The P2P based broadcast system of claim 7, wherein the decoding means is provided for decoding each of said video files.

9. The P2P based broadcast system of claim 7, wherein the DRM-MUX means is provided for multiplexing a DRM header on each of said video file.

10. The P2P based broadcast system of claim 7, wherein the agent means is provided for receiving torrent files to identify locations of tracking means so as to receive said video files and append therein sequentially.

11. The P2P based broadcast system of claim 7, wherein the user interface means is provided for playing said video files so that clients may watch said original video content when said video files being received and appended.

12. The P2P based broadcast system of claim 1, wherein each GOP comprises a set of video frames started with an independent frame (I-frame), and subsequently with a plurality of predictive frame (P-frame) and a plurality of bidirectional frame (B-frame).

13. The P2P based broadcast system of claim 1, wherein said at least one head-end means further comprises an encoding means adapted for compressing each of said video files.

14. The P2P based broadcast system of claim 1, wherein the head-end means further comprises a DRM-H means adapted for providing a digital right management heading operation on each of said video files.

15. The P2P based broadcast system of claim 1, wherein the head-end means further comprises an editing means adapted for editing said video files.

16. The P2P based broadcast system of claim 1, wherein the video head-end server further comprises a EPG means adapted for generating a electronic program guide and delivering said electronic program guide to said peers.

17. A player provided in a peer of a peer-to-peer based broadcast system for receiving a plurality of video files formed by a video content, comprising:
a decoding means provided for decoding a plurality of video files of a video content;
a DRM-MUX means provided for multiplexing a DRM header on each of said video files;
an agent means provided for receiving torrent files to identify locations of tracking means so as to receive said video files and append therein sequentially; and
a user interface means provided for playing said video files so that clients may watch said original video content when said video files being received and appended.

18. A content retrieval method, received by a client via a peer in a peer-to-peer based network, comprising the steps of:
(1) Sending a request to a network management means from a client via a peer for determining what video content to watch;
(2) Getting from said network management means a message containing the number of torrent files, the address of a torrent means for storing said torrent files, and the sequence number for playing said video content;
(3) Fetching said torrent files based on said address of said torrent means and, and queuing said torrent files in said peer;
(4) Receiving a plurality of video files of said video content from some of super seed means and/or other peers;
(5) Combining and appending said plurality of video files in a sequential order;
(6) Processing said sequential video files by a player provided in said peer for watching said video content; and
(7) Repeating the step (1) to (6) if the client stopping said video content and switching another video content.

19. A peer-to-peer based broadcast system for broadcasting video contents, comprising:
at least one video head-end means for receiving a plurality of original video contents and converting each of said original video contents into digital video contents, said video head-end means comprising at least one content repository means for storing said digital video contents;
at least one relay means for receiving said digital video contents from said video head-end means, said relay means comprising a splitter to split each of digital video content into a plurality of video files for each video file being formed of a group of pictures (GOPs) based on said GOPs' boundaries;
a plurality of peers for receiving and broadcasting some of said video files;
at least one super seed means for receiving said video files from said relay means and/or said peers, and broadcasting said files to some of said peers;
at least one network management means for managing connections among said super seed means and said peers, said network management means comprising at least one tracking means for storing all required location information of said video files; and
at least one system management means for providing authentication and authorization for clients on said peers to access to said P2P based broadcast system;
wherein each of said peers comprising a player for processing said video files so as to play said corresponding original video content when said video files being received by the peer.
